(19) United States
(12) Patent Application Publication
(10) Pub. No.: US 2003/0018505 A1
(43) Pub. Date: Jan. 23, 2003

(54) Model for a strategic technology alliance

(75) Inventors: Parasuram V. Pazhayannur, Edina, MN (US); David Bruce Aune, Burnsville, MN (US)

Correspondence Address: MERCHANT & GOULD PC, P.O. BOX 2903, MINNEAPOLIS, MN, 55402-0903, US

(73) Assignee: Seagate Technology LLC

(21) Appl. No.: 10/121,334

(22) Filed: Apr. 12, 2002

Related U.S. Application Data
(63) Continuation-in-part of application No. 10/061,110, filed on Feb. 1, 2002.
(60) Provisional application No. 60/304,963, filed on Jul. 12, 2001.
(60) Provisional application No. 60/304,962, filed on Jul. 12, 2001.

(51) Int. Cl. G06F 17/60

(52) U.S. Cl. 705/7

(57) ABSTRACT

A business model for a strategic alliance of organizations within the Storage Service Provider (SSP) market is disclosed. The strategic alliance creates a combination, or partnership, of a data storage provider, a data security provider and a network infrastructure provider. The strategic alliance is proposed in a plan rendered from an evaluation system that analyzes the core competency of one of the aforementioned providers against core competencies required by the SSP market, which are disclosed herein as data security, data storage and network infrastructure. Because each of the providers is deficient in two of the required core competencies, the plan proposes an alliance between that provider and the other two providers, which each have as its core competency one of the deficient core competencies.

### RELATED APPLICATIONS

This application claims the benefit of priority of U.S. provisional application Serial No. 60/304,963, filed Jul. 12, 2001 and is a continuation-in-part of U.S. patent application Serial No. 10/061,110, filed Feb. 1, 2002.

### FIELD OF THE INVENTION

This application relates generally to strategic business alliances and more particularly to evaluating core competencies of business organizations to form a strategic alliance therewith.

### BACKGROUND OF THE INVENTION

A majority of businesses today have an information technology (IT) department internal to each business to manage and provide the company's IT needs. Some of the services provided by the IT department include, managing data storage servers, data communication networks, software applications, and data backup and recovery. The assets used in providing this service—data storage server, communication networks, software applications—are owned by the company, and in order to deliver this service to the organization, trained personal are hired by the IT department. As organizations grow, so do their storage needs and the total cost of ownership (TOC). IT managers are constantly looking into alternative ways of providing these services at lower costs. In order to see this trend, one must first understand the evolution of data storage architectures in the data storage industry. The trend towards storage outsourcing is best explained using a brief description of the evolution of data storage architectures in the SSP industry, as shown in FIG. 7.

As personal computing became pervasive, distributed storage architecture grew in popularity. As the number of PC users increased over time, the cost of maintaining these distributed storage devices also increased. Centralization of storage servers soon became necessary in order to manage the increasing storage usage. Further, as the demand for storage increased, the cost benefits associated with pooling data storage also increased. However, the consolidation of storage servers and the growing deployment of mission-critical applications on centralized servers, required high capacity, high performance and highly reliable servers with uptimes above 99.999%. These requirements increased the complexity of the servers, which in turn increased the cost of the servers. In addition, maintaining these complex, networked servers required highly trained people, which further increased the TCO. Thus the initial cost savings realized from storage consolidation was soon eroded by the increasing cost of owning these servers as well as from the cost of maintaining these servers. This can be seen graphically in FIG. 8. Estimations for the cost of managing 1 terabyte of storage internally over a 1-year period are up to $1,043,000.

Some incumbent server manufacturers have responded to the increase in TCO by adopting the pay-as-you-go strategy, i.e., partitioning the servers to the exact memory requirements of the user and then allowing them to expand their storage capacity at a later stage as their needs increase. Others have promoted the Network Attached Storage (NAS) technology, as its plug and play feature significantly reduces the cost associated with installing these servers on to the network. However, NAS servers offer no rebate to the costs associated with maintaining these servers. Though the pay-as-you-grow option and NAS servers will ultimately lower the TCO, being a small portion in comparison to the total cost, will not change the status quo. Significant cost saving will be realized only with total elimination of ownership of the storage servers. Estimations for the cost of outsourcing 1 terabyte of storage over a 1-year period are up to $420,000. An anomaly can be made between the pay-as-you-grow option and the way utilities, such as electricity and telephone services, are currently made available to the consumers. Consumers do not own the utilities; however, pay based on their usage. Thus by outsourcing data storage, organizations can significantly lower their capital investment expenditures, which in turn can be reinvested in more value producing activities based on their core competencies.

The need for data storage outsourcing, as mentioned above, comes from the increasing TCO associated with ownership of storage servers. The technologies enabling this change are increases in network bandwidth (LAN and WAN), improvements in bulk data transfer protocols, better data security protocols and the growing use of the Internet. Significant advancements have also been made in the field of bulk data transfer over networks and the Internet. Although no one standard currently dominates, SCSI, Fiber Channel and IP protocols appear to be the most common.

One major outcome of the Internet has been the improvements in data security technologies and protocols. Security technologies such as SSL's and smart-cards are becoming more widely used. However, more needs to be done in this field in order to enable the transfer of data to and from the Internet at 100% reliability. The reason for this is, no matter how fast and ubiquitous the Internet might become, and no matter how extensive the cost savings are due to data storage outsourcing, users will not relinquish control of their data servers if they are uncertain about the security of their data residing at third party locations.

Whereas the responsibility, and thus reliability, of data storage rests on the shoulders of the business, the reliability of the communication networks belongs to a third party network infrastructure provider in no way affiliated with the business. Furthermore, the security of the data being transferred is typically the responsibility of yet another third party (security protocol developers) that is in no way affiliated with either the business or the network infrastructure provider. Such a lack of interdependency begs for pitfalls, downtime and ultimately lost customers for each of the organizations involved.

Furthermore, there are obstacles hindering an otherwise smooth transition from storage ownership to storage outsourcing. These obstacles are best described by analyzing the two models currently used by the Storage Service Provider (SSP) industry to transmit customer data from one server to another server—these are use of virtual private networks and use of the Internet infrastructure. The advantages of utilizing a virtual private network (VPN) to transfer customer data relate to security of the data transfer and high network bandwidth. However, the use of VPNs also has serious drawbacks. First, the infrastructure costs associated with high-speed private networks are enormous, and thus, are not within a reasonable price range for most customers. Second, due to these networks being private, and thus, limited in available bandwidth, the potential customer base in the SSP market is limited to the breadth of the available private network. In sum, due to the enormous up-front entry costs and low market penetration, cash flow generated by using VPNs to transfer customer data in the SSP market is relatively low.

Utilizing the Internet to transfer customer data in the SSP industry addresses several of the drawbacks associated with VPNs. That is, the Internet provides the SSP market with access to a large customer base due to the vast installed network infrastructure that the Internet operates on. Furthermore, the Internet is associated with relatively low bandwidth costs. However, use of the Internet for data transfer in the SSP market is not without drawbacks. First, the Internet is a public network, thereby creating many concerns as to the security of data transmitted over the Internet. Second, in order to utilize the Internet for data transfer in the SSP market, one must purchase access from one of the few network infrastructure owners that control the pipelines for the Internet. As such, these network infrastructure owners are free to, and typically do, fluctuate their access prices as well as unexpectedly terminate relationships with customers. Such practices raise concerns for those customers looking for a long term, fixed or at least stable price commitment.

Although both models currently used in the SSP industry have distinct advantages in the transfer of a business's data, neither model cures the aforementioned lack of interdependency realized in the current SSP market. Furthermore, each of the models is associated with numerous drawbacks, such as those described above. Moreover, it would not be in the best interest of each respective provider in the SSP industry to serve as an all-in-one SSP organization because each provider lacks core competencies needed to build such an organization. For example, a network infrastructure provider lacks not only the expertise in storage technology, but also the expertise required to deliver mission-critical data over the Internet in a secure fashion. That is, the high entry barriers associated with each of the service providers in the SSP industry described above render an attempt to internally develop such an “all-in-one” organization inefficient. It is with respect to these considerations and others that the present invention has been made.

### SUMMARY OF THE INVENTION

In accordance with an embodiment, the present invention is a business model proposing a strategic alliance of organizations within the Storage Service Provider (SSP) market. The strategic alliance is of and between a data storage provider, a network infrastructure owner and a data security provider. The alliance forms a partnership between the data storage provider, the network infrastructure owner and the data security provider that is capable of independently controlling the transfer and storage of customer data in the SSP market without assistance or resources from any other organizations. A partnership is broadly defined and used herein as a conglomeration of two or more separate business organizations formed together to provide services as a single entity. As such, a group effort between each of these three service providers provides a means for operating as a complete SSP, thereby creating interdependency within the partnership.

In accordance with another embodiment, the present invention is a method for defining a strategic alliance of organizations within a specified technological market that requires multiple core competencies for operation as a competitive entity within the market. As such, the market may be the SSP market, which, as noted above, requires competencies in data storage, data transmission and data security. The method of the present invention analyzes a first technology provider having a first core competency against the specified technological market to determine whether the first core competency is one of the multiple core competencies required by the specified technological market. If the first core competency is one of the multiple core competencies required by the specified technological market, the method matches the first technology provider to a second technology provider having a second core competency that is one of the multiple core competencies required by the specified technological market. This matching of technology providers creates a plan for combining the first technology provider with the second technology provider to form the entity that is to operate as a partnership within the specified technological market.

In accordance with yet another embodiment of the present invention, an evaluation system automatically produces a plan for a strategic alliance of organizations within a specified technological market if the system determines that a first technology provider should combine with one or more other technology providers to form a partnership capable of operating in the technological market. The market may be the SSP market, which, as noted above, requires competencies in data storage, data transmission and data security. The evaluation system includes an examination module that analyzes core competencies of the first technology provider against multiple core competencies required by the technological market to determine whether the first technology provider is deficient with respect to any of the required core competencies. If the first technology provider is deficient with respect to one of the required core competencies, an investigation module matches the first technology provider to a second technology provider having the deficient core competency to create the plan for the strategic alliance within the technological market. The strategic alliance proposes a combination of the first technology provider with the second technology provider, thereby forming the partnership that is to operate within the technological market.

In accordance with yet another embodiment, the present invention relates to a method for developing a strategic business plan for a business organization to enter an identified technological market. The strategic business plan proposes a strategy that may be used by the business organization to enter a desired technological market. The strategic business plan may propose that the business organization enter the technological market as a single entity or as part of an alliance between one or more other business organizations. If the strategic business plan proposes that the organization enter the technological market as a single entity, the strategy instructs the business organization to develop core competencies required to enter the technological market using an internal source. Alternatively, the strategy may instruct the business organization to acquire the required core competencies by purchasing such competencies from outside providers. If, however, the strategic business plan proposes that the business organization enter the technological market as part of a strategic alliance, the strategy instructs the business organization to combine with one or more other business organizations to form the alliance.

Embodiments of the invention may be implemented either manually or as a computer-readable program storage device which tangibly embodies a program of instructions executable by a computer system to define a strategic alliance within a specified technological market, such as the SSP market.

These and various other features as well as advantages which characterize the present invention will be apparent from a reading of the following detailed description and a review of the associated drawings.

### BRIEF DESCRIPTION OF THE DRAWINGS

FIG. 1 is a functional diagram of a system for defining a strategic alliance of organizations in a specified technological market in accordance with an embodiment of the present invention.

FIG. 2 depicts a block diagram of a suitable computing environment in which an embodiment of the present invention may be implemented.

FIG. 3 is a flow diagram that illustrates operations for developing a strategic business plan for a business organization in accordance with an embodiment of the present invention.

FIG. 4 is a flow diagram that illustrates operations for defining a strategic alliance of organizations in a specified technological market in accordance with an embodiment of the present invention.

FIG. 5 is a flow diagram that illustrates operations for implementing the strategic alliance of FIG. 4.

FIG. 6 depicts a strategic alliance between a data security provider, a network infrastructure provider and a data storage provider within the storage service provider (SSP) industry in accordance with an embodiment of the present invention.

FIG. 7 depicts evolution of data storage architectures in the SSP industry.

FIG. 8 depicts erosion of initial cost savings realized from storage consolidation by the increasing cost of owning and maintaining servers by organizations with information technology departments.

### DETAILED DESCRIPTION

In the following description of the exemplary embodiment, reference is made to the accompanying drawings that form a part hereof, and in which is shown by way of illustration the specific embodiment in which the invention may be practiced. It is to be understood that other embodiments may be utilized as structural changes may be made without departing from the scope of the present invention.

Embodiments of the present invention may be implemented either manually or as a computer-readable program storage device which tangibly embodies a program of instructions executable by a computer system for defining a strategic alliance within a specified technological market. As such, the logical operations of the various embodiments of the present invention may be implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations making up the embodiments of the present invention described herein are referred to variously as operations, structural devices, acts or modules. It will be recognized by one skilled in the art that these operations, structural devices, acts and modules may be implemented in software, in firmware, in special purpose digital logic, and any combination thereof without deviating from the spirit and scope of the present invention as recited within the claims attached hereto.

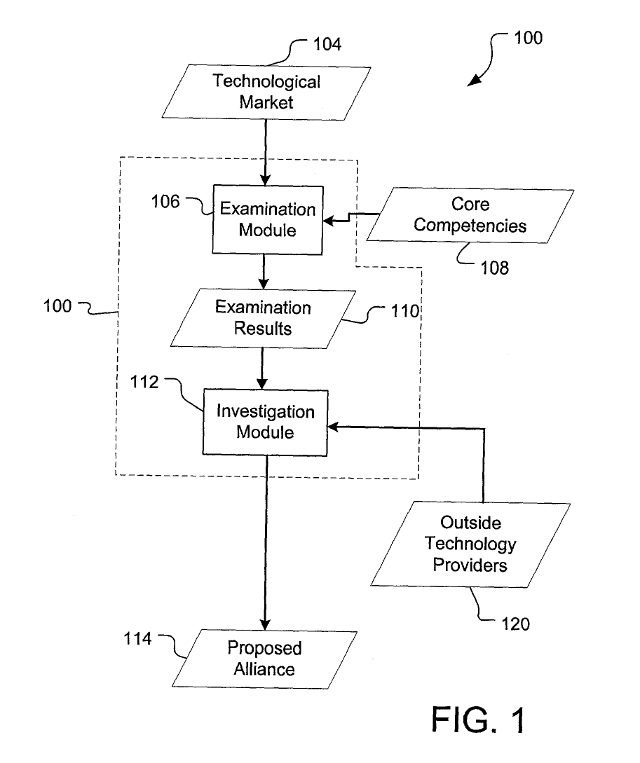

FIG. 1 illustrates a system 100 for defining a strategic alliance within a specified technological market in accordance with an embodiment of the present invention. More specifically, the system 100 defines the strategic alliance by evaluating the technological market against various input parameters to render a strategic alliance of organizations combined to operate as a single entity within the technological market. Thus, the system 100 may be referred to as an “evaluation” system. Although used herein to refer to the storage service provider (SSP) market in accordance with an exemplary embodiment of the present invention, the term “technological market” should be generally construed to encompass any and all industries and markets in the fields of science, mathematics, engineering, pharmaceuticals, banking, medicine, biology, sociology, economy, psychology and any other form of business wherein organizations enter into business agreements with each other in furtherance of the same business goal or objective. The evaluation system 100 is described below as an organization is operating the system 100 to evaluate its core competencies against the technological market such that the system 100 will define a strategic alliance of organizations with which the organization may combine to operate as an independent partnership within the technological market. The terms “organization” and “provider” are used herein interchangeably to refer to an entity that provides some type of service, i.e., data storage, access to network infrastructure or data security, to its customers. A “partnership” is broadly defined and used herein as a conglomeration of two or more separate business organizations formed together to provide services as a single entity. Furthermore, for illustration purposes, the organization utilizing the evaluation system 100 is referred to below as a “test” organization.

The evaluation system 100 includes an examination module 106 and an investigation module 112. The predefined technological market 104 and one or more core competencies 108 of the test organization are input into the examination module 106. Core competencies are broadly defined as those areas of service, technology and/or development in which an organization is most competent. For example, the core competencies of a computer product manufacturer may be computer monitors, computer casings, computer hard drives, computer peripherals and any other computer related software and/or hardware that may be found in or utilized by/with a computer system. For clarity, it is hereinafter assumed that the test organization has only a single core competency, which in accordance with an exemplary embodiment illustrated below, may be data security, network infrastructure or data storage. The evaluation system 100 evaluates the technological market 104 against the test organization's core competency 108 to determine which competency or competencies required for entry into the technological market 104 are not those currently associated with the test organization.

In accordance with a preferred embodiment of the present invention, the technological market 104 is the Storage Service Provider (SSP) market, which requires interaction of the following three core competencies in order to provide a successful SSP service: data security, network infrastructure and data storage. As such, the SSP market is input to the examination module 106 as the technological market 104. For illustrative purposes, the test organization is a network infrastructure owner/provider that provides a network access to its customers. Network infrastructure owners/providers control telecommunications pipelines to provide customers with access to various telecommunications networks over both private line circuits for a single customer, such as virtual private networks, and “public” networks, such as the Internet. Thus, with the test organization being a network infrastructure owner/provider, the core competency 108 input to the examination module 106 is preferably network infrastructure. The examination module 106 evaluates the SSP market against the test organization's core competency to render examination results 110. The examination results 110 identify those core competencies needed to enter the technological market 104 as well as notation on which competencies the organization is deficient in, and thus, will need to secure through an alliance with at least one other organization. Thus, with reference to the above example, the examination results 110 not only indicate that the SSP market requires data security, network infrastructure and data storage competencies, but also that the network infrastructure owner/provider is deficient in the data security and data storage competencies. The examination results 110 may be included in a listing or table, as shown below in Table 1, which illustrates the example described above.

TABLE 1

| Competency | Deficient? |
|---|---|
| Data Security | Yes |
| Data Storage | Yes |
| Network Infrastructure | No |

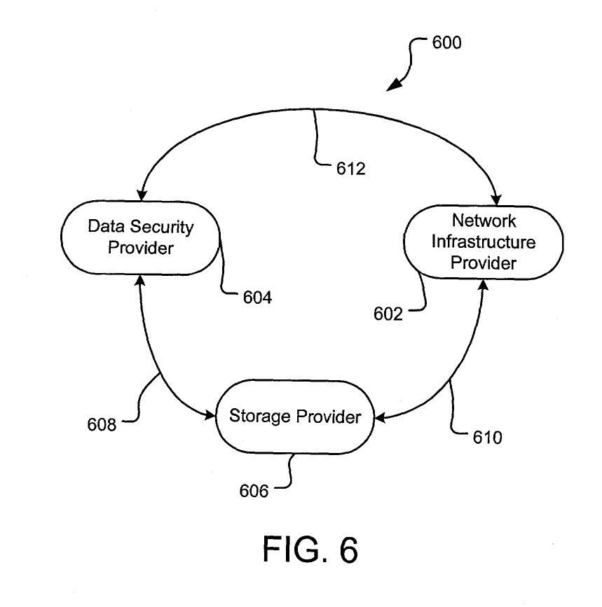

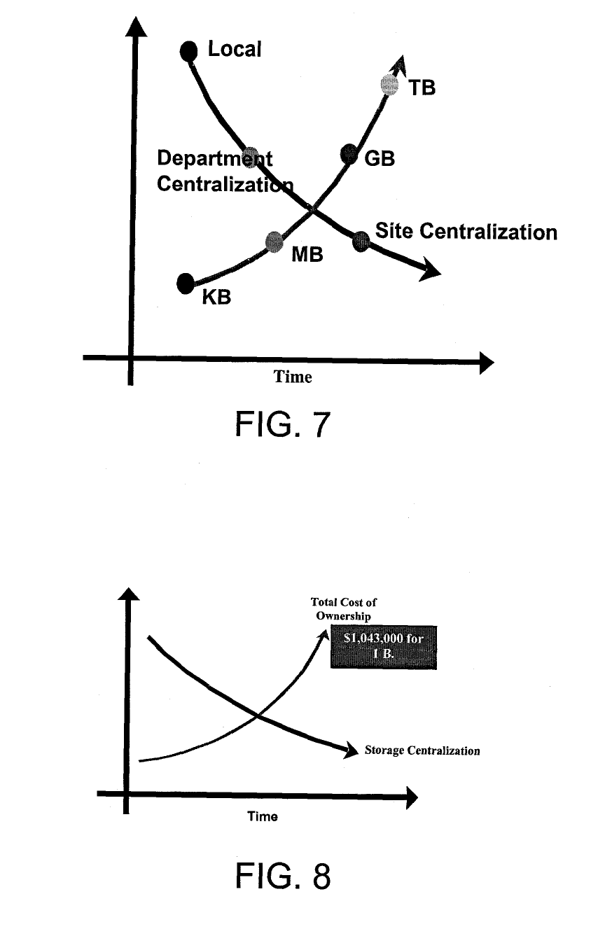

The examination results 110 are input to an investigation module 112 along with various outside technology providers 120. The outside technology providers 120 may be defined as broadly as all possible organizations of all possible core competencies or as narrowly as a selected group of organizations each having the same core competencies. As such, the outside technology providers 120 include all data security providers, all data storage providers and all network infrastructure owners/providers. The investigation module 112 selects one or more outside technology providers 120 to provide each of the core competencies that the test organization lacks, or is deficient in. The investigation utilizes this information to build a strategic alliance plan 114 particular to both the technological market 104 input to the evaluation system 102 and the test organization. The strategic alliance plan 114 suggests an alliance, or partnership, of multiple organizations each having at least one of the core competencies required by the technological market 104. The partnership is a strategic combination of organizations that may operate in the technological market independently without having to utilize resources of an organization not within the partnership. With respect to the example described above, the investigation module 112 thus develops a plan suggesting that the network infrastructure owner/provider enter into agreements with an organization specializing in data security and an organization specializing in data storage to thereafter form a partnership between the three organizations that may operate in the SSP market independently of any other organizations. Such a combination is described in more detail in FIG. 6 in accordance with a preferred embodiment of the present invention.

The strategic alliance plan 114 is output from the evaluation system 102 and submitted to test organization's management for consideration on whether the partnership will be pursued by the test organization. The test organization's management is thus responsible for implementing the strategic alliance plan 114 and taking steps to form the partnership suggested therein. The management may include any person in a position to make decisions on behalf of the organization, including, without limitation, a president, a vice president, a board of director member, a chief executive officer, a chief financial officer, a trustee, a manager, etc.

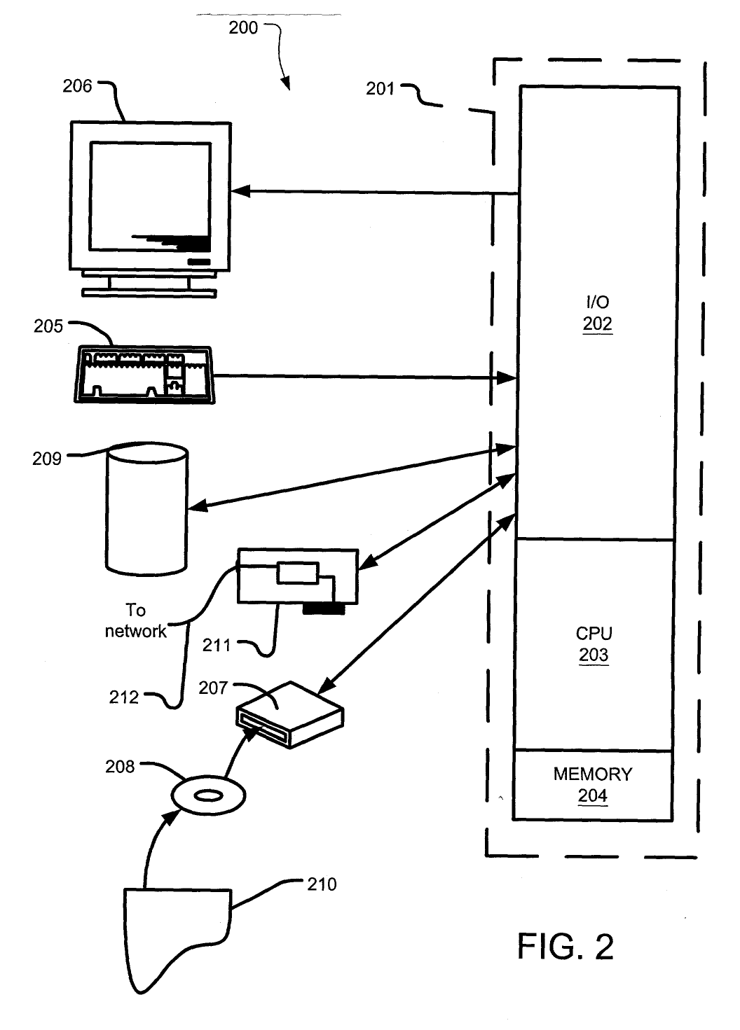

FIG. 2 and the following discussion are intended to provide a brief, general description of a suitable computing environment in which an embodiment of the present invention may be implemented. Although not required, embodiments of the present invention will be described in the general context of computer-executable instructions, such as program modules, objects, components, data structures, etc. that perform particular tasks or implement particular abstract data types. Moreover, those skilled in the art will appreciate that the invention may be practiced with other computing system configurations, including hand-held devices, multiprocessor systems, microprocessor-based or programmable consumer electronics, network PCs, minicomputers, mainframe computers, and the like. The invention may also be practiced in distributed computing environments where tasks are performed by remote processing devices that are linked through a communications network. In a distributed computing environment, program modules may reside in both local and remote memory storage devices.

FIG. 2 depicts a general-purpose computing system 200 capable of executing a program product embodiment of the present invention. One operating environment in which the present invention is potentially useful encompasses the general-purpose computing system 200. In such a system, data and program files may be input to the computing system 200, which reads the files and executes the programs therein. Some of the elements of a general-purpose computing system 200 are shown in FIG. 2 wherein a processor 201 is shown having an input/output (I/O) section 202, a Central Processing Unit (CPU) 203, and a memory section 204. The present invention is optionally implemented in software devices loaded in memory 204 and/or stored on a configured CD-ROM 208 or storage unit 209 thereby transforming the computing system 200 to a special purpose machine for implementing the present invention.

The I/O section 202 is connected to keyboard 205, display unit 206, disk storage unit 209, and disk drive unit 207. In accordance with one embodiment, the disk drive unit 207 is a CD-ROM driver unit capable of reading the CD-ROM medium 208, which typically contains programs 210 and data. Computer program products containing mechanisms to effectuate the systems and methods in accordance with the present invention may reside in the memory section 204, on a disk storage unit 209, or on the CD-ROM medium 208 of such a system. Alternatively, disk drive unit 207 may be replaced or supplemented by a floppy drive unit, a tape drive unit, or other storage medium drive unit. The network adapter 211 is capable of connecting the computing system 200 to a network of remote computers via the network link 212. Examples of such systems include SPARC systems offered by Sun Microsystems, Inc., personal computers offered by IBM Corporation and by other manufacturers of IBM-compatible personal computers, and other systems running a UNIX-based or other operating system. A remote computer may be a desktop computer, a server, a router, a network PC (personal computer), a peer device or other common network node, and typically includes many or all of the elements described above relative to the computing system 200. Logical connections may include a local area network (LAN) or a wide area network (WAN). Such networking environments are commonplace in offices, enterprise-wide computer networks, intranets, and the Internet.

In accordance with a program product embodiment of the present invention, software instructions such as those directed toward communicating data between a client and a server; detecting product usage data, analyzing data, and generating reports may be executed by CPU 203, and data such products usage data, corporate data, and supplemental data generated from product usage data or input from other sources may be stored in memory section 204, or on disk storage unit 209, disk drive unit 207 or other storage medium units coupled to the system.

As is familiar to those skilled in the art, the computing system 200 further comprises an operating system and usually one or more application programs. The operating system comprises a set of programs that control the operation of the computing system 200, control the allocation of resources, provide a graphical user interface to the user and includes certain utility programs. An application program is software that runs on top of the operating system software and uses computer resources made available through the operating system to perform application specific tasks desired by the user. Preferably, the operating system employs a graphical user interface where the display output of an application program is presented in a rectangular area on the screen of the display device 206 and is also multitasking (executing computing tasks in multiple threads), such as Microsoft Corporation's “WINDOWS 95”, “WINDOWS 98”, “WINDOWS 2000” or “WINDOWS NT” operating systems, IBM's OS/2 WARP, Apple's MACINTOSH SYSTEM 8 operating system, X-windows, etc.

In accordance with the practices of persons skilled in the art of computer programming, the present invention is described below with reference to acts and symbolic representations of operations that are performed by the computing system 200, a separate storage controller or a separate tape drive (not shown), unless indicated otherwise. Such acts and operations are sometimes referred to as being computer-executed. It will be appreciated that the acts and symbolically represented operations include the manipulations by the CPU 203 of electrical signals representing data bits which causes a resulting transformation or reduction of the electrical signal representation, and the maintenance of data bits at memory locations in the memory 204, the configured CD-ROM 208 or the storage unit 209 to thereby reconfigure or otherwise alter the operation of the computing system 200, as well as other processing signals. The memory locations where data bits are maintained are physical locations that have particular electrical, magnetic, or optical properties corresponding to the data bits.

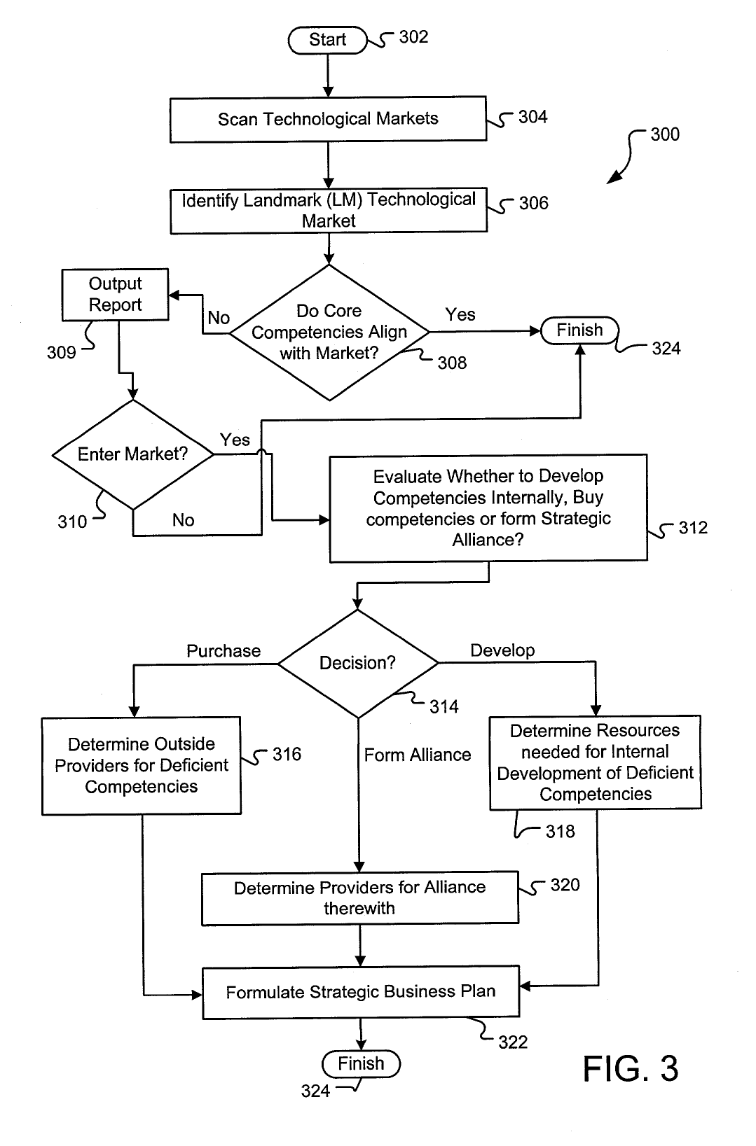

With both the manual and the computing environment embodiments in mind, FIG. 3 illustrates a process (hereinafter, “development process”) of operations for developing a strategic business plan for a business organization in accordance with an embodiment of the present invention. The development process comprises an operation flow beginning with a start operation 302 and concluding with a terminate operation 324. The terms “technological market” and “core competency” are described below in the same manner as described above with the evaluation system 100, and thus, should be construed in the same manner as noted above. Likewise, the terms “organization” and “provider” are used herein interchangeably to refer to an entity that provides some type of service, i.e., data storage, access to network infrastructure or data security, to customers. Further, for illustration purposes, the organization utilizing the development process 300 is referred to below as a “test” organization.

At the beginning of the development process 300, the operation flow immediately passes from the start operation 302 to a scan operation 304. The scan operation 304 scans a relevant market area for landmark technological markets. The relevant market area may be broadly or narrowly defined by the test organization. For example, the test organization may be a network infrastructure provider and, thus, the relevant market area may be defined by the organization to be any market area pertaining to telecommunications, i.e., communications over a distance. The scan operation 304 may use Van Wck's Strategic Technology Scanning and Forecasting (STSF) framework to identify landmark technological markets within the relevant market area. In identifying a landmark technological market, Van Wck's STSF scans all technological markets defined within the relevant market area irrespective of the core competencies associated with the test organization. STSF may be defined as a systematic process for looking into the future to identify important technologies for the purpose of aiding in policy formation, planning, and decision-making. STSF is a framework that assists corporations in identifying the potential of emerging technologies. The objective of a strategic technology scan is to obtain technology foresight, a key element for sustained competitive advantage.

From the scan operation 304, the operation flow passes to an extract operation 306. The extract operation 306 identifies a technological market within the relevant market area considered to be a “landmark” technological market. In accordance with an embodiment, the term “landmark technology” is defined and used herein to refer to an emerging technology that, after consideration, may be worthwhile for an organization to pursue. As such, a landmark technology may be either a technology for development by an organization or a technology that would be utilized by an organization in the development of products or services. A landmark technological market for one particular organization may be an irrelevant technological market for another organization. Plainly stated, the notion of landmark technological markets is relative and specific to the test organization, i.e., the organization conducting the technology scan. From the extract operation 306, the operation flow passes to a first query operation 308.

The first query operation 308 evaluates whether the test organization is deficient with respect to any core competencies required to enter the landmark technological market. The term “deficient” is used herein to define a situation wherein that a specific organization is neither associated with nor currently has a specific core competency. As such, the first query operation 308 determines whether the test organization can enter the landmark technological market based on the current core competencies of the test organization. If the test organization currently has each of the required core competencies, then the operation flow concludes at the terminate operation 324 as no strategic business plan is required for the test organization to operate as a business in the landmark technological market. If, however, the test organization does not currently have all required core competencies, then the operation flow passes to a first prompt operation 309. The first prompt operation 309 outputs a report illustrating that the test organization does not currently have the required core competencies required to operate as a business within the landmark technological market as well as depicting the core competencies in which the test organization is deficient. In accordance with alternative embodiments, the report is submitted to either the test organization or a computing system programmed to render decisions on behalf of the organization. The test organization or the computing system programmed to render decisions on behalf of the organization utilize the submitted report to render a decision on whether or not the organization will enter the landmark technological market. From the first prompt operation 309, the operation flow passes to a second query operation 310.

The second query operation 310 receives the decision on whether or not the organization will enter the landmark technological market rendered by either the test organization or the computing system making decisions on behalf of the organization and branches the operation flow accordingly. If the test organization, or computing system acting on behalf of the organization, elects not to enter the landmark technological market, the second query operation 310 branches the operation flow to the terminate operation 324 and the operation flow concludes.

If, however, the test organization elects to enter the landmark technological market, the second query operation 310 branches the operation flow to a second prompt operation 312. The second prompt operation 312 outputs an inquiry to either the test organization or the computing system programmed to make decisions on behalf of the test organization as to whether the test organization should internally develop the deficient core competencies, purchase the core competencies from an outside provider or form a strategic alliance with one or more other business organizations having the one or more deficient core competencies. Following the second prompt operation 312, the operation flow passes to third query operation 310.

The third query operation 314 receives the decision on whether to develop the deficient core competencies, purchase the core competencies from an outside provider or form a strategic alliance with one or more other business organizations rendered by either the test organization or the computing system operating on behalf of the organization and branches the operation flow accordingly. If the decision rendered is to purchase the deficient core competencies from an outside provider, the third query operation 314 branches the operation flow to a select provider operation 316. The select provider operation 316 determines which outside providers are to be used in providing the deficient core competencies. For example, if the test organization is a network infrastructure provider and the landmark technological market is SSP, the select provider operation 316 preferably selects a data security provider and a data storage provider to provide data security and data storage, respectively. From the select provider operation 316, the operation flow passes to a formulate plan operation 322. The formulate plan operation 322 creates a strategic business plan suggesting that the test organization purchase the deficient core competencies—data security and data storage—from the selected data security provider and the selected data storage provider, respectively. As described in more detail above and with respect to FIGS. 4, 5 and 3, purchasing data security and data storage competencies from an outside source is not an efficient business arrangement for network infrastructure providers, but rather an inferior business strategy with respect to other alternatives, namely formation of a strategic alliance. From the formulate operation 322, the operation flow concludes at the terminate operation 324.

If the decision rendered is to internally develop the deficient core competencies, the third query operation 314 branches the operation flow to a select resources operation 318. The select resources operation 318 determines which resources are needed for the test organization to develop the deficient core competencies. For example, if the test organization is a network infrastructure provider and the landmark technological market is SSP, the select resources operation 318 preferably selects data security resources and data storage resources to develop data security and data storage competencies, respectively. Such resources may include personnel specialized in the areas of data security and data storage or services/products required in the development of such areas. From the select resources operation 318, the operation flow passes to a formulate plan operation 322. The formulate plan operation 322 creates a strategic business plan suggesting that the test organization internally develop the deficient core competencies—data security and data storage. As described in more detail above and with respect to FIGS. 4, 5 and 3, internally developing data security and data storage competencies is not an efficient use of resources for network infrastructure providers, but rather an inferior business strategy with respect to other alternatives, namely formation of a strategic alliance. From the formulate operation 322, the operation flow concludes at the terminate operation 324.

If the decision rendered is to form a strategic alliance with one or more other business organizations having the deficient core competencies, the third query operation 314 branches the operation flow to a select partner operation 320. The select partner operation 320 selects one or more business organizations having the one or more deficient core competencies. By selecting organizations such that each of the deficient competencies match either a selected organizations or the test organization, the select partner operation 320 renders a conglomeration sufficient to operate as an entity in the landmark technological market. For example, if the test organization is a network infrastructure provider and the landmark technological market is SSP, the select partner operation 320 preferably selects a data security provider and a data storage provider as partners to the strategic alliance. From the select partner operation 320, the operation flow passes to a formulate plan operation 322. The formulate plan operation 322 creates a strategic business plan suggesting that the test organization form a partnership with the selected data security provider and the selected data storage provider. With respect to the strategic alliance proposed, the strategic business plan is referred to herein as a strategic business model in accordance with a preferred embodiment of the present invention. The strategic business model of this embodiment of the present invention is described in FIG. 3 using reference numeral. As described in more detail above and with respect to FIGS. 4, 5 and 3, forming a strategic alliance with a data security provider and a data storage provider is an efficient business arrangement for network infrastructure providers, and thus a superior business strategy with respect to other alternatives, namely purchasing or developing the deficient core competencies. From the formulate operation 322, the operation flow concludes at the terminate operation 324.

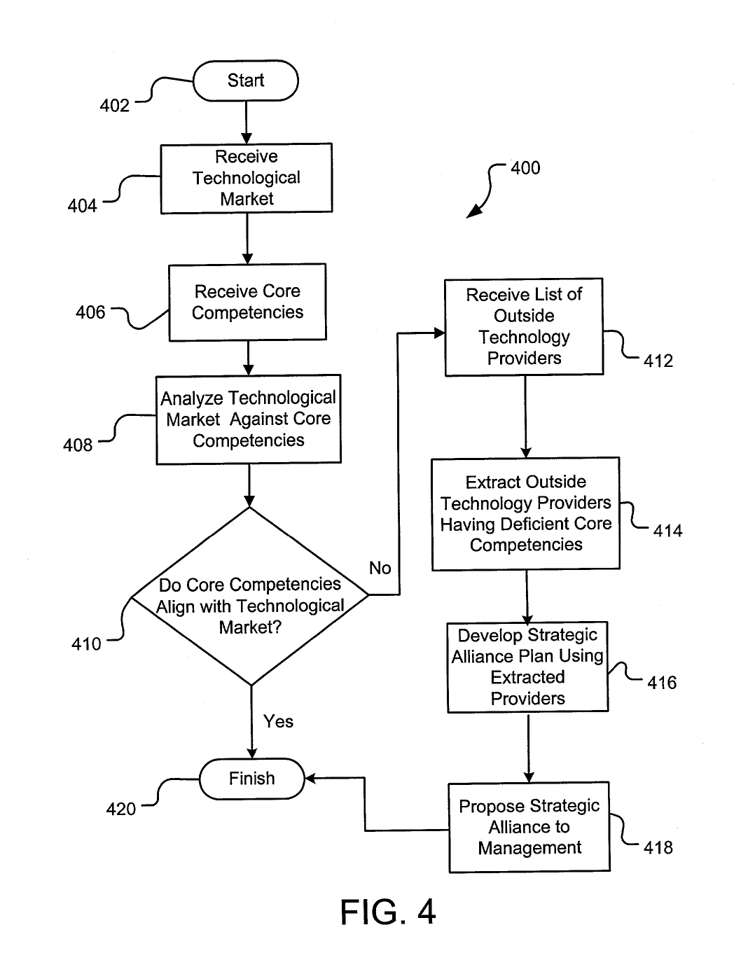

FIG. 4 illustrates operations for defining a strategic alliance of organizations combined to operate as a single, independent entity within a specified technological market. More specifically, FIG. 4 shows a process 400 for evaluating (“evaluation process”) the technological market against various input parameters to render a strategic alliance plan and thereafter propose the combination suggested therein to an organization which is to be included in the alliance. For illustration purposes, the organization utilizing the evaluation process 400 is referred to below as a “test” organization. The evaluation process 400 comprises an operation flow beginning with a start operation 402 and concluding with a terminate operation 420.

At the beginning of the evaluation process 400, the operation flow immediately passes from the start operation 402 to a first receive operation 404. The first receive operation 404 receives a technological market within which the requested strategic alliance will operate. In accordance with a preferred embodiment, the technological market is specified, i.e., input, by the test organization. From the first receive operation 404, the operation flow passes to a second receive operation 406. The second receive operation 406 awaits arrival and thereafter receives selected core competencies against which the technological strategy will be evaluated. In accordance with a preferred embodiment, the core competencies are the core competencies associated with, and thus specified by, the test organization.

From the second receive operation 406, the operation flow passes to an analyze operation 408. The analyze operation 408 evaluates the specified technological market against the specified core competencies to compile a record of whether the specified core competencies satisfactorily meet all the core competencies required to form an independent strategic alliance in the specified technological market. From the analyze operation 408, the operation flow passes to a query operation 410. The query operation 410 reviews the record created by the analyze operation 408 to determine whether each of the core competencies required by the specified technological market are met by the core competencies specified by the test organization. If so, the operation flow concludes at the terminate operation 420 because an alliance of organizations is not needed for the test organization to independently operate in the specified technological market. In contrast, if each of the core competencies required by the specified technological market are not met, the operation flow passes to a third receive operation 412. The third receive operation 412 receives a list, or record, of sets of outside technology providers. Each set has at least one core competency separate from each other set and each of the technology providers in a set have the same core competencies as the other providers in the set thereby making up one or more representative technology provider types categorized by the associated core competency. From the third receive operation 412, the operation flow passes to an extract operation 414.

The extract operation 414 reviews the list received by the receive operation 412 and extracts the sets of technology providers having the core competencies in which the test organization is deficient, as determined by the analyze operation 408. From the extract operation 414, the operation flow passes to a develop alliance operation 416. The develop alliance operation 416 generates a plan for a strategic alliance, or partnership, of organizations using the extracted sets of technology providers. The plan suggests that the test organization enter into an agreement with an organization in each of the sets of technology providers to form a partnership capable of independently operating in the specified technological market. In accordance with a preferred embodiment, a business model for such an alliance/partnership is depicted in FIG. 6 and described in the associated text below.

After the strategic alliance plan is generated, the operation flow passes to a propose alliance operation 418. The propose alliance operation 418 submits the strategic alliance plan to the management of the test organization, and therefore, proposes the strategic alliance to the test organization's management for review. From the propose alliance operation 418, the operation flow concludes with the terminate operation 420. Once received, the test organization's management evaluates the proposed alliance/partnership to determine the feasibility of actually forming the alliance/partnership with the suggested technology providers. This evaluation is preferably administered as a joint effort of each technology provider suggested by the proposed alliance/partnership.

In accordance with a more specific embodiment, the extract operation 414 selects a specific technology provider out of each of the extracted sets of technology providers thereby designating one technology provider for each of the deficient core competencies as an organization to be included in the proposed alliance. As such, the develop alliance plan operation 416 may generate a strategic alliance plan using the extracted technology providers for each of the deficient core competencies. That is, the strategic alliance plan may suggest combining the test organization and the extracted specific technology providers to form a partnership capable of independently operating in the technological market. Once received, the test organization's management evaluates the proposed alliance to determine the feasibility of actually forming the alliance/partnership with the specific technology providers belonging to the proposed alliance.

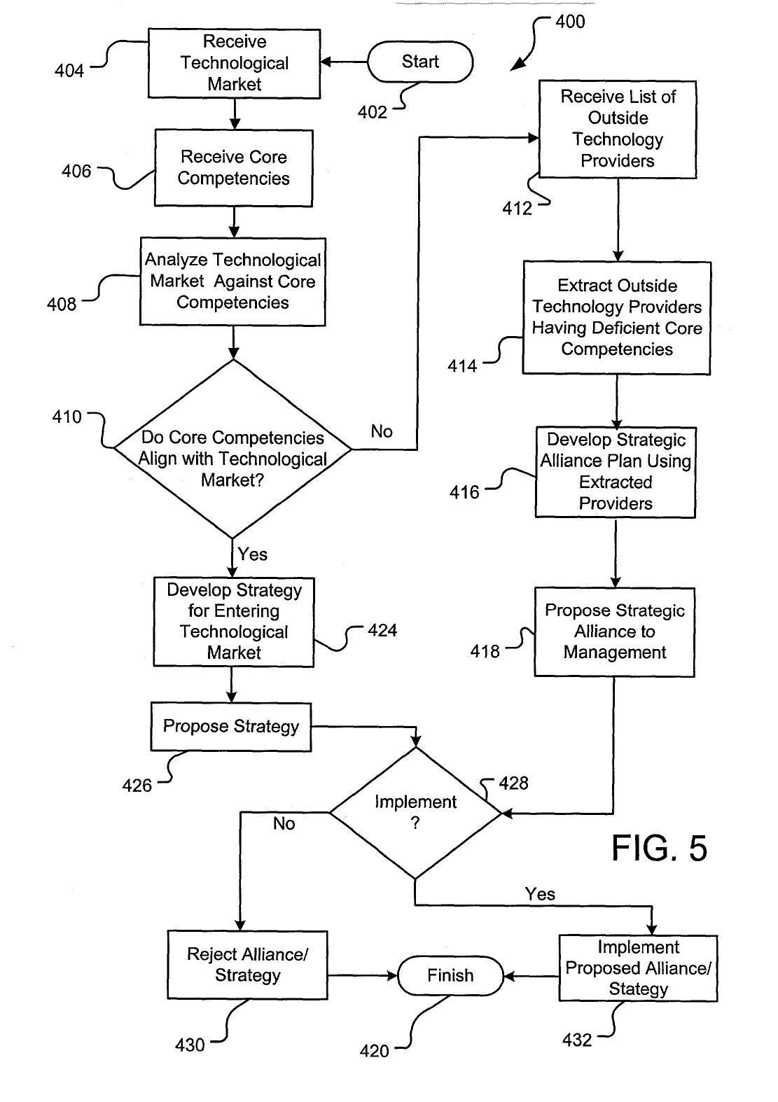

FIG. 5 shows a flow diagram that illustrates operations of the evaluation process 400 in more detail in accordance with a particular embodiment of the present invention. If the query operation 410 determines that each of the core competencies required by the specified technological market are met by the core competencies submitted by the test organization, then the operation flow of the evaluation process 400 passes to a develop strategy operation 424. The develop strategy operation 424 develops a strategy for the organization to enter the specified technological market without an alliance with another organization. That is, the develop strategy operation 424 creates a plan suggesting actions that need to be taken by the test organization for the test organization to enter the specified technological market independently and without combining with any other organizations. After the strategy is created by the develop strategy operation 424, the operation flow passes to a propose strategy operation 426. The propose strategy operation 426 submits the strategy to the test organization's management for review. The management evaluates the proposed strategy to determine the feasibility of implementing the strategy, and thus, actually entering the specified technological market.

Following the propose strategy operation 426 and the propose alliance operation 418, the operation flow passes to a second query operation 428. The second query operation 428 waits for and thereafter receives the management's decision on whether to pursue the strategy or alliance. Once received, the second query operation passes the operation flow to either a reject operation 430 or an implement operation 422. That is, if the second query operation 428 determines that the management has decided to pursue the strategy or alliance, the operation flow passes to the implement operation 432. The implement operation 432 implements the strategy or alliance on behalf of the test organization. Implementation of a proposed alliance is described with reference to FIG. 6 in accordance with a preferred embodiment of the present invention. From the implementation operation 432, the operation flow concludes at the terminate operation 420. If however, the second query operation 428 determines that the management has opted to not pursue the strategy or alliance, the operation flow passes directly to a reject operation 430. The reject operation 430 rejects the strategy or alliance and the operation flow concludes at the terminate operation 420.

FIG. 6 is a business model 600 for the Storage Service Provider (SSP) technological market in accordance with a preferred embodiment of the present invention. The business model 600 is based on a strategic alliance between a network infrastructure owner/provider 602, a data storage provider 606 and a data security provider 604. Such a strategic alliance is shown in the model 600 using double-headed arrow lines 608, 610 and 612, which represent agreements between each of the providers 602, 604 and 606. The alliance forms a partnership capable of independently operating in the SSP market. Such a partnership enables management of each of the organizations to align the organization's corporate strategies with the requirements and characteristics of the SSP market, thereby better positioning each of the providers for success in this emerging market.

In accordance with a preferred embodiment, three core competencies are required in order for an entity to effectively compete as an independent SSP: data security means through which the SSP protects its customers' data, data storage means through which the SSP stores its customer' data and network infrastructure means through which the SSP controls transmission of its customers' data. The network infrastructure owner/provider 602 provides network infrastructure as its core competency to the partnership formed under the business model 600. However, the network infrastructure owner/provider 602 is deficient with respect to the other two core competencies—data security and data storage. The data security provider 604 provides data security as its core competency to the partnership formed under the business model 600. However, the data security provider 604 is deficient with respect to the other two core competencies—network infrastructure and data storage. The data storage provider 606 provides data storage as its core competency to the partnership formed under the business model 600. However, the data storage provider 606 is deficient with respect to the other two core competencies—network infrastructure and data security. Each of the three providers making up the alliance is described in greater detail below.

The data storage provider 606 provides data storage as its contribution to the partnership so that the partnership may operate in the SSP market. The storage provided by the storage provider 606 may be in the form of standalone servers or storage subsystems. A disc drive manufacturer is preferably the organization serving as the data storage provider 606 because a majority of the costs of a server comes from the costs of disc drives. Thus, considering that a relatively large amount of storage capacity is required in the SSP industry, a disc drive manufacturer introduces the partnership venture to capital-intensive investment. Further, the disc drive manufacturer being part of the alliance may place the partnership in position to capture a majority share of the SSP market due to the disc drive manufacturer's access to virtually unlimited storage capacity.

The data security provider 604 provides the necessary security protocols required to effectively secure data transmitted and stored by the partnership formed under the model 600. The data security provider 604 is part of the alliance/partnership because the willingness of users to contract with the partnership depends directly on the level of confidence that the users have on the security of their data being transmitted and stored by the partnership. That is, any loss or theft of data may result in significant losses to the client, and thus, an eventual loss of clients to the partnership.

The network infrastructure owner/provider 602 provides access to transmission media for the data controlled by the SSP partnership. Network infrastructure owners/providers control the telecommunication services through which the data will be transmitted. As noted above, one reason that the network infrastructure provider is a suggested partner in the alliance is because the telecommunication services market is associated with high entry barriers. The few network infrastructure owners/providers 602 available for alliance currently control a majority of the world's telecommunications backbones and access thereto, thereby making it difficult, in not almost impossible, for a new network infrastructure provider to enter this particular market. Thus, having the network infrastructure owner/provider 602 in the partnership allows the partnership to enter the SSP market without concern of such high entry barriers. Furthermore, network infrastructure providers have access to a large installed Internet customer base, thereby introducing the partnership to this customer base.

Application of the SSP market and one of the aforementioned providers (502, 604 and 606) to the evaluation process 400 shown in FIG. 4 preferably renders the strategic alliance required by the business model 600. For illustration purposes, the data storage provider 606 is used herein as the organization to which the evaluation process 400 is applied. With reference to the evaluation process 400, the first receive operation 404 receives the SSP market as the specified technological market and the second receive operation 406 receives data storage as the core competency.

The analyze operation 408 then compiles a record depicting that the data storage provider 606 does not have two of the core competencies—data security and network infrastructure—required to be an SSP. The query operation 410 reviews the record created by the analyze operation 408 and determines that each of the core competencies required to be an SSP are not met by the single core competency (data storage) submitted by the data storage provider 606. Thus, the third receive operation 412 receives a list, or record, of sets of outside technology providers and the extract operation 414 reviews the list to extract the sets of data security and network infrastructure providers. The develop alliance plan operation 416 then generates the strategic alliance for the data storage provider 606 using the extracted sets of technology providers. The strategic alliance thus suggests that the data storage provider 606 enter into an agreement with an organization from the data security provider set and an organization from the network infrastructure provider set. Such an alliance is developed by the develop alliance plan operation 416 to suggest a partnership that will independently operate in the SSP market without having to contract for resources from any other type of provider.

In summary, the present invention may be viewed as a method (such as process 400) for defining a strategic alliance of business organizations within a specified technological market (such as 104). The specified technological market requires multiple core competencies for operation within the market. The method comprises analyzing (such as in operation 408) a first technology provider (such as 606) having a first core competency (such as 108) against the specified technological market to determine whether the first core competency is one of the multiple core competencies required by the specified technological market. The method also comprises matching (such as in operations 412 and 414) the first technology provider to a second technology provider (such as 604) having a second core competency that is one of the multiple core competencies required by the specified technological market to render a plan (such as 114) for combining the first technology provider with the second technology provider to form a partnership for operating within the specified technological market if the first core competency is one of the multiple core competencies required by the specified technological market. The method may further comprise matching (such as in operations 412 and 414) the first technology provider and the second technology provider to a third technology provider (such as 602) having a third core competency that is one of the multiple core competencies required by the specified technological market to render a plan for combining the first technology provider, the second technology provider and the third technology provider into the partnership if the first core competency is one of the multiple core competencies required by the specified technological market.

In accordance with an embodiment of the present invention the specified technological market may be a Storage Service Provider (SSP) market and the partnership forms an SSP responsible for controlling the transmission and storage of customer data. In this embodiment, the first technology provider is a data storage provider (such as 606), the second technology provider is a data security provider (such as 604) and the third technology provider is a network infrastructure provider (such as 602).

In accordance with yet another embodiment, the matching act (such as in operations 412 and 414) may comprise receiving (such as in operation 412) a list (such as 120) of technology providers, wherein the second technology provider is included on the list, examining (such as in operation 414) the list to determine that the second core competency is required by the specified technological market and extracting (such as in operation 414) from the list the second technology provider. The method of the present invention may also comprise proposing (such as in operation 418) the plan to management of the first technology provider for determination on whether the plan will be accepted by the first technology provider as well as proposing (such as in operation 418) the plan to management of the second technology provider for determination on whether the plan will be accepted by the second technology provider. If the management of both the first technology provider and the second technology provider accept the plan, implementing (such as in operation 432) the plan to form the partnership between the first technology provider and the second technology provider.

In accordance with another embodiment, the present invention may be viewed as a computer-readable program storage device which tangibly embodies a program of instructions executable by a computer system to define a strategic alliance of business organizations within a specified technological market (such as 104). Therefore, each of the above-described operations and implementations may be performed by a program storage device readable by a computer system tangibly embodying a program of instructions executable by the computer system to perform the above-described method (400).

In accordance with another embodiment, the present invention may be viewed as a system (such as 100) for evaluating whether a first technology provider (such as 606) should combine with one or more other business organizations (such as 604 and 606) to form a strategic alliance within a specified technological market (such as 104) requiring multiple core competencies for operation within the market. In this embodiment, the system comprises an examination module (such as 106) analyzing core competencies (such as 108) of the first technology provider against the multiple core competencies required by the technological market to determine whether the first technology provider is deficient with respect to any of the multiple core competencies required by the technological market. The system also includes an investigation module (such as 112).

The investigation module matches the first technology provider to a second technology provider (such as 604) having an associated core competency that is one of the multiple core competencies required by the specified technological market. The investigation module also renders a plan (such as 114) for combining the first technology provider with the second technology provider to form a partnership for operating within the specified technological market if the first technology provider is deficient with respect to the core competency associated with the second technology provider. In accordance with an embodiment, the investigation module may receive a list (such as 120) of technology providers that includes the second technology provider. The investigation module thereafter examines the list to determine that the second core competency is required by the specified technological market and thereafter extracts from the list the second technology provider. In accordance with a further embodiment, the investigation module matches the first technology provider and the second technology provider to a third technology provider (such as 602) having an associated core competency that is one of the multiple core competencies required by the specified technological market if the first technology provider and the second technology provider are deficient with respect to the core competency associated with the third technology provider.

As with the method (such as process 400) of the present invention, the specified technological market may be a Storage Service Provider (SSP) market wherein the partnership forms an SSP responsible for controlling transmission and storage of customer data. In this embodiment, the first technology provider is a data storage provider (such as 606), the second technology provider is a data security provider (such as 604) and the third technology provider is a network infrastructure provider (such as 602).

In accordance with yet a further embodiment, the present invention may be viewed as a business model (such as 600) for a strategic alliance of organizations forming a Storage Service Provider (SSP). The SSP transmits customer data over a telecommunications network and stores the customer data in a storage device operably coupled to the telecommunications network. The SSP comprises a data storage provider (such as 606) operable to set up and maintain the storage device for the SSP, wherein data is passed between the storage device and the telecommunications network using a server-connected therebetween. The SSP also comprises a data security provider (such as 604) operable to secure the customer data against theft and loss while the data is transmitted over the telecommunications network and stored in the storage device. Finally, the SSP includes a network infrastructure provider (such as 602) operable to set up and maintain the network infrastructure for the SSP such that the strategic alliance is formed between the data storage provider, the data security provider and the network infrastructure provider to operate as the SSP.

The data storage provider may be a hard disc drive manufacturer, and thus, the storage device may be a hard disc drive. The telecommunications network may be a virtual private network (VPN) or the Internet. In accordance with another embodiment, the strategic alliance may include an insurance provider insuring customers of the SSP against loss and theft of data as the data is transmitted over the communications network and stored in the storage device.

In accordance with yet another embodiment, the present invention may be viewed as a method (such as process 300) for developing a strategic business plan for a business organization (such as 606). This method identifies a landmark technological market (such as 104) relevant to a market area predetermined by the business organization. A business entity is required to have a plurality of core competencies to operate as a provider within the landmark technological market. The method evaluates (such as in operation 308) whether the business organization is deficient with respect to one or more of the plurality of core competencies. If the business organization is deficient with respect to one or more of the plurality of core competencies, the method receives (such as in operation 310) an instruction from the business organization on whether to enter the identified technological market. If the business organization elects to enter the identified technological market, the method determines (such as in operations 316, 318 and 320) a source operable to provide each of the deficient core competencies. Finally, the method renders (such as in operation 322) a strategic business plan that proposes integration of the source of each of the deficient core competencies with the business organization in order to form the business entity that is to operate as a provider within the technological market.

In accordance with a first embodiment, in determining a source operable to provide each of the deficient core competencies, the method selects (such as in operation 318) the business organization as the source operable to provide each of the deficient core competencies. In this first embodiment, the strategic business plan proposes that the business organization develop each of the deficient core competencies using internal resources. In accordance with a second embodiment, in determining a source operable to provide each of the deficient core competencies, the method selects (such as in operation 316) one or more outside providers (such as 602 and 604) as the source operable to provide each of the deficient core competencies. In this second embodiment, the strategic business plan proposes that the business organization purchase each of the deficient core competencies from the one or more outside providers.

In accordance with a third embodiment, in determining a source operable to provide each of the deficient core competencies, the method selects (such as in operation 320) one or more outside providers (such as 602 and 604) as the source operable to provide each of the deficient core competencies. In this third embodiment, the strategic business plan proposes that the business organization form a strategic alliance with the one or more outside providers thereby forming a business entity operable to operate as a provider in the technological market. In accordance with this third embodiment, in evaluating whether the business organization is deficient with respect to one or more of the plurality of core competencies, the method may analyze (such as in operation 410) core competencies of the business organization against the plurality of core competencies required by the technological market to determine whether the business organization is deficient with respect to any of the plurality of core competencies required by the technological market. As such, in selecting one or more outside providers, the method may match (such as in operations 412 and 414) the business organization to a second provider (such as 604) having an associated core competency that is one of the multiple core competencies required by the identified technological market and rendering a plan for combining the business organization with the second provider to form a partnership for operating within the specified technological market if the business organization is deficient with respect to the core competency associated with the second provider. Furthermore, the method may match (such as in operations 412 and 414) the first provider and the second provider to a third provider (such as 606) having an associated core competency that is one of the multiple core competencies required by the identified technological market if the first provider and the second provider are deficient with respect to the core competency associated with the third provider.

As with the earlier described method (400), the identified technological market may be a Storage Service Provider (SSP) market and the proposed strategic alliance forms an SSP responsible for controlling transmission and storage of customer data. As such, the first provider is a data storage provider (such as 606), the second provider is a data security provider (such as 604) and the third provider is a network infrastructure provider (such as 602). The method may also scan (such as in operation 304) the relevant market area using Van Wck's model for Strategic Technology Scanning and Forecasting (STSF) to identify the landmark technological market.

In accordance with even yet another embodiment, the present invention may be viewed as a computer-readable program storage device which tangibly embodies a program of instructions executable by a computer system to developing a strategic business plan for a business organization. Therefore, each of the above-described operations and implementations may be performed by a program storage device readable by a computer system tangibly embodying a program of instructions executable by the computer system to perform the above-described method (300).

It will be clear that the present invention is well adapted to attain the ends and advantages mentioned as well as those inherent therein. While a presently preferred embodiment has been described for purposes of this disclosure, various changes and modifications may be made which are well within the scope of the present invention. For example, the business model 600 may include an insurance provider in the strategic alliance of providers. The insurance provider provides monetary protection to the partnership's clients in case of data loss or theft, thereby alleviating some of the issues that the clients may have with data security. Moreover, the business model 600 is described above as being formed using the evaluation system and processes of FIGS. 1, 4 and 5 in accordance with an exemplary embodiment of the present invention. However, the business model 600 should not be limited to being formed using the aforementioned processes, but rather may be formed using any other system or process in which a strategic alliance may be created between the network infrastructure owner/provider 602, the data storage provider 606 and the data security provider 604. Furthermore, although the strategic alliances evaluated, formed and described herein as partnerships between one or more business organizations, such a strategic alliance may be any other type or form of business arrangement between separate business organizations combined to provide specific services or products. Numerous other changes may be made which will readily suggest themselves to those skilled in the art and which are encompassed in the spirit of the invention disclosed and as defined in the appended claims.

What is claimed is:

1. A method for developing a strategic business plan for a business organization, the method comprising acts of:
(a) identifying a technological market relevant to a market area predetermined by the business organization, wherein the technological market requires a business entity to have a plurality of specific core competencies in order to operate as a provider within the technological market;
(b) evaluating whether the business organization lacks one or more of the specific core competencies;
(c) if the business organization lacks one or more of the specific core competencies, receiving an instruction from the business organization on whether to enter the identified technological market;
(d) if the business organization elects to enter the identified technological market, determining one or more sources operable to provide the specific core competencies that the business organization lacks; and
(e) proposing integration of the one or more sources with the business organization to form the business entity for operating as a provider within the identified technological market.

2. The method of claim 1, wherein the determining act (d) comprises an act of:
selecting the business organization as the one or more sources, wherein the proposing act (e) creates a strategic business plan instructing the business organization to develop each of the specific core competencies that the business organization lacks using internal resources.

3. The method of claim 1, wherein the determining act (d) comprises an act of:
selecting one or more outside providers as the one or more sources, wherein proposing act (e) creates a strategic business plan instructing the business organization to purchase each of the specific core competencies that the business organization lacks from the one or more outside providers.

4. The method of claim 1, wherein the determining act (d) comprises an act of:
(d)(i) selecting one or more outside providers as the one or more sources operable to provide each of the specific core competencies that the business organization lacks, wherein the proposing act (e) creates a strategic business plan instructing the business organization to combine with the one or more outside providers thereby forming the business entity for operating within the identified technological market.

5. The method of claim 4, wherein the business organization has a first core competency that is one of the specific core competencies and the selecting act (d)(i) comprises:
(d)(i)(A) matching the business organization to a second business organization having a second core competency that is one of the specific core competencies that the business organization lacks.

6. The method of claim 5, wherein the strategic business plan instructs the business organization to combine with the second business organization to form the business entity for operating within the identified technological market.

7. The method of claim 6, wherein the selecting act (d)(i) further comprises:
(d)(i)(B) matching the business organization and the second business organization to a third business organization having a third core competency that is one of the specific core competencies that the business organization lacks.

8. The method of claim 7, wherein the strategic business plan instructs the business organization to combine with the second business organization and the third business organization to form the business entity for operating within the identified technological market.

9. The method of claim 8, wherein the identified technological market is a Storage Service Provider (SSP) market and the business entity is an SSP responsible for controlling transmission and storage of customer data.

10. The method of claim 9, wherein the business organization is a data storage provider, the second business organization is a data security provider and the third business organization is a network infrastructure provider.

11. The method of claim 6, wherein the matching act (d)(i)(A) comprises acts of:
(d)(iii)(A)(1) receiving a list of technology providers, wherein the second business organization is included on the list;
(d)(iii)(A)(2) examining the list to identify a specific business organization having one of the specific core competencies that the business organization lacks; and
(d)(iii)(A)(3) extracting from the list the second business organization as the specific technology provider.

12. A program storage device readable by a computer system tangibly embodying a program of instructions executable by the computer system to perform the method of claim 6.

13. A program storage device readable by a computer system tangibly embodying a program of instructions executable by the computer system to perform the method of claim 1.

14. A system for evaluating whether a first technology provider should combine with one or more other business organizations to form a strategic alliance within a specified technological market, wherein the specified technological market requires multiple core competencies for operation within the market, the system comprising:
an examination module analyzing core competencies of the first technology provider against the multiple core competencies required by the technological market to determine whether the first technology provider is deficient with respect to any of the multiple core competencies required by the technological market; and
an investigation module matching the first technology provider to a second technology provider having an associated core competency that is one of the multiple core competencies required by the specified technological market and rendering a plan for combining the first technology provider with the second technology provider to form a partnership for operating within the specified technological market if the first technology provider is deficient with respect to the core competency associated with the second technology provider.

15. The system of claim 14, wherein the investigation module further matches the first technology provider and the second technology provider to a third technology provider having an associated core competency that is one of the multiple core competencies required by the specified technological market if the first technology provider and the second technology provider are deficient with respect to the core competency associated with the third technology provider.

16. The system of claim 15, wherein the specified technological market is a Storage Service Provider (SSP) market and the partnership forms an SSP responsible for controlling transmission and storage of customer data.

17. The system of claim 16, wherein the first technology provider is a data storage provider, the second technology provider is a data security provider and the third technology provider is a network infrastructure provider.

18. The system of claim 14, wherein the investigation module receives a list of technology providers that includes the second technology provider, examines the list to determine that the second core competency is required by the specified technological market and thereafter extracts from the list the second technology provider.

19. A business model for a strategic alliance of organizations forming a Storage Service Provider (SSP) for transmitting customer data over a telecommunications network and storing the customer data in a storage device operably coupled to the telecommunications network, the business model comprising:
a data storage provider setting up and maintaining the storage device for the SSP, wherein data is passed between the storage device and the telecommunications network using a server connected therebetween;
a data security provider securing the customer data against theft and loss while the data is transmitted over the telecommunications network and stored in the storage device; and
a network infrastructure provider setting up and maintaining the network infrastructure for the SSP such that the strategic alliance is formed between the data storage provider, the data security provider and the network infrastructure provider to operate as the SSP.

20. The business model of claim 19, wherein the data storage provider is a disc drive manufacturer and the storage device is a disc drive.

21. The business model of claim 19, wherein the telecommunications network is a virtual private network (VPN).

22. The business model of claim 19, wherein the telecommunications network is the Internet.

23. The business model of claim 19 further comprising:
an insurance provider insuring customers of the SSP against loss and theft of data as the data is transmitted over the communications network and stored in the storage device.
